(19) United States
(12) Patent Application Publication
(10) Pub. No.: US 2012/0259760 A1
(43) Pub. Date: Oct. 11, 2012

(54) HYBRID ENERGY MARKET AND CURRENCY SYSTEM FOR TOTAL ENERGY MANAGEMENT

(76) Inventors: Sgouris Sgouridis, Abu Dhabi (AE); Scott W. Kennedy, Abu Dhabi (AE)

(21) Appl. No.: 13/394,670

(22) PCT Filed: Sep. 10, 2010
(86) PCT No.: PCT/IB2010/002408

§ 371 Date: Jun. 22, 2012

Related U.S. Application Data
(60) Provisional application No. 61/241,706, filed on Sep. 11, 2009.

(30) Foreign Application Priority Data
Sep. 11, 2009 (GB) 0916022.7

(51) Int. Cl. G06Q 50/06

(52) U.S. Cl. 705/37

(57) ABSTRACT

A hybrid energy market and currency system is provided to manage energy consumption in an energy market comprising a community of users. A central energy authority issues energy currency units to users and sets an exchange rate between the energy currency units and a monetary currency unit, thereby setting a variable price for energy. Energy currency units have a defined validity period at the end of which the energy currency unit is automatically converted to monetary currency units by the central energy authority. Users consume energy currency units through use of energy consumptive services, such as domestic consumption of electricity and water, and through use of transportation. Users are also able to buy additional energy currency units from the central energy authority, and to sell them back. Users cannot speculatively trade energy currency units. Prices are set by comparing the cumulative actual and desired demand

### FIELD OF THE INVENTION

The present invention relates to a hybrid energy market and currency system for total energy management.

### DESCRIPTION OF THE BACKGROUND ART

Most products and services have an associated energy cost. Yet for the majority, there are currently no means, accessible to ordinary consumers, for monitoring and accounting for their embedded energy usage on a physical or financial basis. Energy costs are instead aggregated and hidden behind the final sticker price. Since more than 80% of the world's primary energy consumption originates from fossil fuels (IEA, 2009), the unpriced externalities of greenhouse gas emissions are thus doubly disguised. For a society based on an inexpensive and unlimited energy supply, the simplicity of a single pricing system with hidden energy costs far outweighs the benefits of more transparent energy pricing and accounting. Our energy supply, however, is neither cheap nor unlimited; Earth's fossil resources are finite and the cost of their use is escalated by their scarcity and their impact on the climate and the environment. Yet, due to systemic inertia, neither of these conditions have become constraining enough to force significant change. With the dual threat of climate change and peaking of accessible fossil resources, new mechanisms for how we price and account for energy use in our daily transactions will be needed.

Charging users an energy price that reflects the cost of supply is a key component for appropriately managing demand. In the electricity sector, the concept of a spot electricity price based on its marginal cost of supply at a particular time and location was originally developed by Schweppe (1988) to more accurately reflect the true cost of generation and delivery as well as to incentivize consumers to respond accordingly. Locationally based marginal pricing, as it is now called, has subsequently become a standard and essential feature for competitive wholesale electricity markets (Chandley, 2001; Cramton, 2003). As these markets have become increasingly refined, they have produced very useful pricing signals that can accurately reflect supply-side costs, guide operating decisions of suppliers, and inform investment decisions in new generation and network capacity (Shrestha and Fonseka, 2004; Roh et al. 2007). There has been less success, however, on using them to encourage meaningful participation from the demand side. Some of the reasons for limited demand response to dynamic pricing signals include a rudimentary metering infrastructure with a limited ability to communicate variable prices and end-user consumption, a limited technical ability for end-users to respond to prices, a resistance to seemingly complex pricing schemes at the retail level, and the inertia in the electricity sector towards incorporating market designs that encourage participation from small and medium-sized consumers. There has, however, been considerable experience with incentive-based demand side management (DSM) programs that focus on emergency load reductions or interruptible load contracts between utilities and large electricity consumers (Zarnikau, 2008). Large end-users tend to be more price-sensitive and willing to enter into a contractual agreement with a utility to reduce their demand, if called on only occasionally, for some financial compensation. Under vertically integrated utilities, the costs and benefits of such programs are borne by a single party, which makes their implementation much easier. These types of DSM programs serve their purpose relatively well when the primary motivation for demand response has been peak load management by a utility; either in response to extreme daily peaks or as an emergency response to loss of supply. It is much more difficult to use these programs for routine demand shaping or to influence the load of a large number of smaller retail consumers. For this purpose, it is necessary to implement new mechanisms in retail electricity markets that are constantly active, not only in response to emergencies.

In order to increase the information value of retail electricity prices (or all energy prices), retail energy markets must necessarily become more sophisticated. The obstacles mentioned above, in terms of the metering infrastructure, device-responsiveness, consumer resistance to complexity and market inertia, must therefore be overcome. In recent years, there has been tremendous interest in upgrading the capability of electricity distribution networks to incorporate more intelligent electricity meters, to expand two-way communication between users and suppliers, and to deploy “smart” appliances that have the ability to adjust load automatically in response to variable signals. These innovations will address the major physical infrastructure obstacles to demand response, but more work is still needed on reforming retail markets to ensure that appropriate signals are created in the first place. There has been very limited amount of empirical work to estimate how consumers respond to real-time electricity prices (Patrick and Wolak, 2001; Lijesen, 2007). Limitations result from the fact that the very few consumers actually see these hourly or half-hourly prices. Lijesen (2007) notes that consumers tend to be more price responsive over the long-term (i.e. more than one year), while they show very little sensitivity in the shorter-term. Using hourly spot price data from the Amsterdam Power Exchange, we calculate a price elasticity of only −0.029 for the load participating in the exchange. More empirical evidence is certainly needed, but it is clear that providing an hourly price does not guarantee a significant response among retail customers.

Electricity consumption is only one aspect of total energy use in urban systems. Due to the complexity of most manufacturing processes and supply chains, it is difficult to apply a piecemeal approach to energy management. It is preferable instead to devise an integrated energy pricing scheme that can account for and reveal the interdependencies among different forms of energy and energy services. Developing such a system for an urban economy requires both a strong rationale for overcoming institutional inertia in a fragmented energy sector, and an information and computer technology (ICT) infrastructure that can monitor and communicate real-time information on energy use across multiple services.

Masdar City in Abu Dhabi provides an example of a planned “eco-city” that satisfies both of these requirements; with a target for one hundred percent renewable energy generation and zero carbon emissions, satisfying the rationale, and its proposed extensive energy metering network, providing the ICT infrastructure. Masdar City is, as of 2009, the largest planned development intended to rely on renewable energy sources for its entire energy balance. Masdar City was envisioned as a showcase project to spearhead the Abu Dhabi government's effort to diversify its economy by becoming an important player in the renewable energy sector. As a result, the key design requirement of Masdar City is to become the world's first city of this scale to achieve net zero carbon emissions for its operations. When the city is completed, the energy needs of its 50,000 residents and 40,000 daily commuters will be generated on site through a portfolio of energy sources. Utilizing its desert location in Abu Dhabi, UAE, the primary energy sources of the city will include roof-top photovoltaics, concentrated solar trough collectors, evacuated tube solar thermal collectors, geothermal sources and a waste-to-energy facility. Resident transportation will rely on electrified mass transit (Light Rail Transit) for its intercity transport and a combination of walking, cycling, and automated electric taxis (Personal Rapid Transit) for intra-city mobility. Being thus constrained in its energy balance, very high levels of energy efficiency need to be designed in every aspect of the city's operation.

Device-oriented energy efficiency measures alone are not sufficient to meet the supply side targets of Masdar City if not supplemented by energy awareness and end-user behavioral changes towards satisfying energy demand. Difficulties in application aside, the real-time pricing systems referenced above focus solely on electricity usage, do not provide the user with any explicit energy constraint, and cannot extend to other forms of energy consumption.

### SUMMARY OF THE INVENTION

We propose an alternative to real-time price-based demand management through the introduction of a retail energy credit scheme that forms the basis of an Energy-Based Currency System (EBCS). This system is being proposed in the context of Masdar City's constraints and capabilities, but the general concept is applicable to a range of cities, conurbations, smaller settlements or other regions with varying resources and infrastructures.

While the invention is described in the following with reference to Masdar City, it will be understood that any city is meant, and that the concepts apply more generally to any settlement type with defined energy supply.

Each energy credit in the EBCS entitles the credit holder to consume a standardized quantity of energy from multiple end-use services (e.g. electricity, public transit, hot water) or to avoid that consumption and sell the corresponding credit through a centrally administered exchange. The quantity of credits issued in the city will be directly linked to the total and finite supply of renewable energy generated within the city boundary. The scarcity of credits can therefore be used to incentivize consumers not to exceed their local energy supply. Other renewable energy credit or certificate schemes have been implemented elsewhere, most notably the Renewable Energy Certificate (REC) system in the US and Australia, and Tradable Green Certificates (TGC) in Europe. These systems have focused primarily on credit sales between energy suppliers, thereby allowing utilities to meet their renewable energy targets at the lowest possible cost while encouraging investment in renewable energy technologies (Berry, 2002). The energy credit system proposed here focuses instead on the final energy consumers and encompasses all energy related services within a bounded geographic region.

The proposed EBCS is designed to allow the city, or other region with similar constraints, to meet a sustainability target by:
(i) Providing continuous information on energy usage and offering a simple and flexible platform to compare and trade-off between services on a physical and financial basis;
(ii) Aggregating the energy input across all steps of the value chain for city services;
(iii) Rewarding energy conservation while not imposing undue constraints on energy usage;
(iv) Providing a mechanism for consistent energy accounting that is transparent and permits auditing;
(v) Informing future energy planning and financially supporting further investment in energy infrastructure.

We propose the introduction of an energy-based parallel currency as a means to ease the transition to an energy-conscious living. A transition to a renewable energy-based society will require the rethinking of how people perceive and relate to energy. Rooted in a world with abundant fossil energy resources, internal and external energy costs have been opaque to casual energy consumers. This status quo will first be challenged by communities that draw a large fraction of their primary energy use from constrained renewable energy sources. The proposed energy credit system—referred to as the Masdar Energy Credit (MEC) system in the following—is a way of translating the fundamental aspects behind (renewable) energy generation and usage into a tangible reality for all users with built-in tangibility to incentivize collectively sustainable behavior. It is a concept that can be replicable by other communities or regions with similar constraints worldwide.

The energy credits currency corresponds one-to-one with a chosen unit of energy supply (e.g. kWh). In principle, the total amount of MECs issued equals to the energy supply of the city. MECs are distributed to city users (residents, commercial entities, employees, and visitors) on a subscription basis or by advance purchase in the case of visitors. As MECs are being used, the city's “sustainable” supply of energy is being depleted therefore a spot market pricing mechanism is introduced to translate MECs to “fiat” currency ($) using a continuously variable exchange rate.

The MEC system is primarily intended to meet the sustainable energy balance targets of a community but it can be adjusted to achieve peak shaving or load shifting goals. More importantly, it is a tool designed to educate on the limitations of sustainable energy supply without imposing constraints other than a variable price. By choosing equal distribution and revenue neutrality, equity considerations are addressed and frugal users can stand to benefit while no users are unduly restricted in their ability to meet their perceived needs. Providing a continuous feedback mechanism, it can raise an energy conscience—an awareness of when the community needs the help of its citizens to meet its ambitious sustainability goals.

In particular, the invention provides in one aspect a method of managing consumption of energy in an energy market comprising a community of users, the method comprising: providing energy generation facilities; providing a central energy authority which issues energy currency units to users and which sets an exchange rate between the energy currency units and a monetary currency unit, the exchange rate varying with time, thereby setting a variable price for energy; permitting users to consume energy currency units through use of energy consumptive services within the energy market; and permitting users to buy and sell energy currency units from and to the central energy authority at the then prevailing exchange rate.

The price of energy is preferably set having regard to the difference between energy consumption and energy demand, more preferably having regard to the difference between cumulative energy consumption and cumulative energy demand over a defined time period. The time period may be: a day, a week, a month or a year or any other desired period. In one embodiment, the price of energy is adjusted by an amount proportional to the difference between cumulative energy consumption and cumulative energy demand over a defined time period.

Each energy currency unit has a defined validity period at the end of which the energy currency unit is automatically converted to monetary currency units by the central energy authority. This avoids build up of energy consumption units over time.

The energy constraint may be a physical constraint governed by the capacity of the energy generation facilities, or a portion of the energy generation facilities, e.g. defined by the amount of power that is capable of being generated. This may also be variable over time in the case that solar power generation or hydroelectric power generation is used. Alternately, the energy constraint may be governed by a requirement that a defined fraction of the energy market's consumption of energy is generated by certain kinds of energy generation facility, e.g. a certain percentage of energy must be generated from renewable sources.

A grid connection can be provided to remote energy generation facilities serving a remote energy market, thereby permitting export of energy to and import of energy from the remote energy market. The central energy authority may then set further exchange rates to price energy currency units exported to and imported from the remote energy market, so that the energy market has an internal price, an import price and an export price for energy. The import price may include a premium to cover the cost of offsetting the carbon emission of the imported energy. The export price may also advantageously be greater than the internal price to provide a financial incentive for users to reduce energy consumption.

The invention further relates to an energy market operating according to the above methods, such as a city or other settlement area or community.

### BRIEF DESCRIPTION OF THE DRAWINGS

FIG. 1 is a graph showing a matrix of energy and capacity constraints.

FIG. 2 is a plot of annual load and required generation using either an annual or monthly energy balance.

### DETAILED DESCRIPTION

The following describes how energy credits can be used as a means to reflect the physical reality of energy consumption, while creating a market mechanism that allows users in aggregate to efficiently manage their total consumption in accordance with supply-side constraints imposed by renewable energy targets. The application can be a city such as Masdar, with a 100% renewable energy target, or other regions and municipalities with lower energy-based targets.

We first provide an overview of the basic concept and defines the commonly use terms. We then discuss how the energy credits will be issued and allocated and the coverage of the system. We then describe in greater detail the rules and functions of the energy credit spot and forward markets. Finally, we present a summary.

As a potential application in Masdar City, the EBCS will be known as the Masdar Energy Credit (MEC) system, which will introduce a scheme of standardized energy credits as a parallel currency for purchasing the energy component of various goods and services. For example, the use of public transit will require the user to surrender a given number of credits corresponding to the energy required to provide that service. The physical basis for the credits is intended to make energy generation a tangible reality for the users, while the flexibility of trading-off between energy use and financial compensation makes energy fungible. The primary motivation behind the MEC system is to promote more efficient energy use, thus allowing Masdar City to satisfy its goal of 100% renewable energy generation without imposing restrictive and arbitrary constraints on energy use.

As part of making energy tangible, we define the ergo as the currency unit of the MEC system. One ergo is equivalent to one unit of energy. The chosen energy unit could be one kWh, one Joule or any other amount as the price can be scaled accordingly. Ergos are issued in limited batches by a centralized energy administration, hereafter referred to as the City Energy Authority (CEA), such that the number of credits issued matches the forecasted energy generation. By limiting the issuance of ergos to equal the total forecasted renewable energy output over a defined time horizon, energy consumers are made immediately aware of the finite energy resource and are incentivized to limit their energy consumption to the available supply over that period. Ergos have an expiration time signifying the difficulty of energy storage. They can be exchanged for the energy portion of services until their expiration, by which time they will be redeemed for their monetary value if they remain unused.

Energy is made fungible through the creation of an active energy credit exchange market. The ergo spot market is a retail market that allows active trading of ergos creating a continuously variable exchange rate between ergos and monetary currency. The ergo spot market allows users to surrender ergos for the provision of a service (i.e. pay ergos in exchange for a service) or to sell ergos and receive the equivalent monetary value based on their spot price at the time of the sale. Through the market, a credit holder that chooses to reduce lighting levels, for example, could sell extra credits to an individual who requires an extra trip on the public transit system. In this way, the aggregate energy supply limit can be maintained through trades between users and between services. Ergos are not available for speculative trading, i.e., they cannot be bought for resale. If extra ergos are required to pay for energy usage above one's allocated limit, a consumer simply consumes the service and is charged for the corresponding extra ergos at the current spot market rate, thereby purchasing and surrendering the extra ergos simultaneously. Because of this feature, the CEA is the only active buyer and can therefore set the market price. A price setting algorithm is proposed that adjusts the ergo exchange rates by comparing the actual and desired demand curves.

All users have continuous access to their energy credit and monetary accounts using an interactive smart-phone type device that can be used for:
Surrendering ergos to “pay” for a service;
Buying and immediately surrendering ergos bought at the spot price if a user's ergo account is depleted;
Selling ergos when the spot market price is considered by the user (or his/her standing order) opportune;
Displaying real-time information on energy credit and monetary balances of the user, the current spot market price for ergos, ancillary information like purchase history, user footprint, historical carbon emissions, etc.;
Automating standing orders, alerts, and user preferences to make the use of the system intuitive.

A short definition of the terms introduced in the above description of the MEC system are also listed below in order to facilitate reading and to be used as reference. The following sections describe in greater detail how the system is envisioned to operate.

Masdar Energy Credit (MEC) system: A retail energy market system using energy credits as parallel currency for all energy-related transactions. Designed to provide integrated energy demand management for bounded regions with specific constraints on energy (primarily renewable) usage. Covers a wide range of services and users and intends to make energy tangible and fungible in order to facilitate the transition to an energy-conscious lifestyle.

City Energy Authority (CEA): Centralized authority that administers the MEC system by issuing ergos and setting their market price. It can also advise energy generation capacity expansion by assisting with demand forecasting. CEA intermediates between power producers and users, but need not own energy generation facilities.

Ergo: Energy currency unit of the MEC system. A single credit corresponds to a standardized amount of energy at the point of consumption accounting for distribution losses.

Ergo validity period: Ergos can be actively sold or redeemed until their expiration. The duration depends on the goals of the system. Unused ergos are automatically bought back at the end of the validity period.

Ergo markets: Spot and forward markets where ergos can be sold or redeemed by consumers and sold or purchased by the CEA. Used as the primary mechanism for facilitating efficient load shifting and demand reductions based on variable availability of energy supply.

User accounts: MEC system users have two active accounts registered with CEA, one for ergos and one monetary.

Useful for informing user decisions about their total energy usage patterns.

The MEC System for Demand Management is now described.

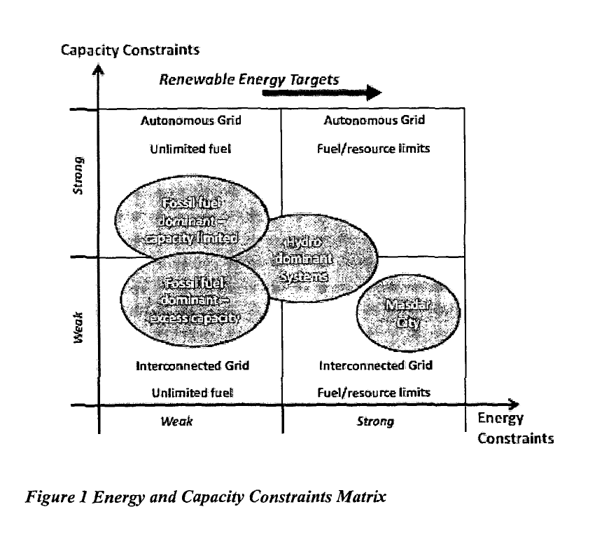

Demand management programs come in many forms, from variable real-time pricing to the direct control of loads by electric utilities. In the majority of instances, they have focused predominantly on managing peak demand due to the hard constraints on available generation capacity. Managing total energy consumption, however, has been less emphasized since the total fuel consumed over time tends not to be as constrained as the available capacity. In the case of Masdar City or any region that aspires to meet a renewable energy penetration target, the renewable fuel supply is not unlimited and the renewable plants usually operate at or very near their full available capacity. In this situation, an upper limit on the total renewable energy generation clearly exists. Specifically for Masdar City, peak demand is less constrained, as the City can rely on the much larger Abu Dhabi grid when local capacity is insufficient. This situation creates strong energy constraints, due to the target to satisfy 100% of energy consumption, over time, by the local renewable resources, and weak capacity constraints, due to the connection with the Abu Dhabi grid. The presence of strong energy constraints and weak capacity constraints, as in Masdar City, requires different demand management mechanisms than those that have been developed for regions dominated by capacity constraints. This situation is not unique to Masdar. Any city or region that defines a fixed percentage of energy that must be supplied by renewable resources has introduced a strong energy constraint in addition to any existing capacity constraints. The relative influence of capacity and energy constraints is illustrated by the four quadrant matrix in FIG. 1. In the figure, the range of states from interconnected to autonomous is defined by the ratio of endogenous to exogenous peak power capacity. A fully autonomous system would have no access to external power capacity, whereas an interconnected system would have a relatively high ratio. Masdar City falls in the lower right quadrant where an interconnected grid that relies on a resource limited supply (i.e., solar power) is dominated by energy constraints. The opposite situation is represented by an autonomous system with an unlimited fuel supply. Most fossil-dominant power grids that suffer from network and capacity constraints would fall in this quadrant. Other examples are shown for the two remaining quadrants. It is important to note that the availability of energy storage can reduce the capacity constraints for a system with renewable energy supply (shifting downward), but does nothing to address the energy constraints. Furthermore, it is not necessary for a system to rely on 100% renewable energy to be subject to strong energy constraints. As long as some fixed percentage of energy consumption must be satisfied by renewable resources, there is an active energy constraints. The proposed energy credit system, especially the mechanisms for credit issuance, pricing and expiration, is well suited for bounded regions with strong energy constraints, thus facilitating the achievement of strict targets of renewable energy supply.

The MEC system is designed to be an integrated system for total energy management and accounting on a citywide scale. As a result, both the range of services covered and the user base need to be as comprehensive as possible. In order for the MEC system to be used as an energy accounting mechanism for the city, all possible users of energy in the city should be within the system's boundaries including individuals and organizations. The allocation amongst them may vary based on the system design but it should still be all-encompassing. As a result, users are defined as any entity that is consuming energy-based services within the system's boundary including: residents, commuter employees, businesses, visitors and the CEA representing the municipality.

As it would be logistically and politically difficult to start with a similarly comprehensive coverage in services, the initial range of services that are envisioned to be covered includes:
Electricity
Air conditioning (cooling and heating)
Water
Hot water
Transportation
Waste management
Common utility services

A product or service that is included in the MEC system will have an ergo “price” associated with its energy costs and a monetary price associated with overhead and non-energy related costs. In order to facilitate the transactions, an e-wallet application operated through an IP-enabled smart device would be a necessary tool for the MEC system implementation. In the initial stages, the MEC transaction would cover only the direct energy portion of the service or product. As the system expands, the energy value chain behind a service or product will be easily accounted for and, as a result, the energy price-tag would fully account the “embodied” (direct and indirect) energy expenditure. In an expanded system locally produced items (e.g. local produce) and non-utility services (e.g. maintenance, facility usage, medical visits etc) can be within the system's scope.

Delivery losses also need to be included in the system coverage as the total allocation of credits must sum up to the local energy generation. For a given transaction, a user's account will be deducted a quantity of ergos according to the energy used at the point of consumption, plus some fixed portion of time-averaged losses. As the MEC system is applied to a dense urban area, it is anticipated that sharing losses equally over all transactions is both an equitable and simple solution. The conceptual formula for pricing of services in the MEC scheme is given in Eq. 1,

EPᵢ=(E_{direct,i}+E_{indirect,i})/(1−lf) (1)

where EPᵢ is the ergo price (ergos that need to be surrendered) for service i, E_{direct,i} is the direct energy costs at the point of consumption for providing service i, E_{indirect,i} is the embodied energy costs for providing service i (optional), and lf is the loss factor representing the delivery losses. The loss factor can be calculated by averaging the total losses over an averaging period N,

$$lf = {\sum }_{n = 1}^{N} 1 - \frac{{C}_{n}}{{G}_{n}} \qquad ( 2 )$$

where Cₙ is the total energy consumed (at the location where the service is provided) over a single issuance period n and Gₙ is the total generation over the same period.

Services that rely on thermal energy (e.g. hot water from solar thermal collectors) are also included in the scope of services covered by MECs. An adjustment factor will be applied to the quantity of MECs required for thermal as opposed to electric energy services to reflect thermal energy's lower grade and the lower lifecycle energy cost of providing thermal energy.

From the time of issuance, ergos can be stored for use at any time throughout their validity period. The duration of the validity period therefore determines the time scale over which the CEA has the most influence in managing demand. If ergos are issued and expire hourly, then the CEA can directly adjust hour to hour demand by allocating an appropriate number of credits, whereas with a monthly issuance and validity period the CEA would only have direct influence on total monthly demand. The variable exchange price for MECs can influence demand changes within a validity period, but this mechanism is not as controllable as the allocation process, as will be described later. In practice the validity period can be chosen according to which of two demand management objectives is of greater priority:
(i) Peak demand management (strong capacity constraint)
(ii) Energy management (strong energy constraint)

The flexibility and capacity of dispatchable generation and energy storage mechanisms will define at what point between the two extremes a certain MEC system application lies. In the Masdar City case, a connection to the external electricity grid provides essentially unlimited “storage” for the city and energy management becomes a much higher priority than managing peak loads. Even in this case, a move to a stronger capacity constraint level (e.g. monthly or shorter energy balance) could be founded in an effort to emulate more realistic conditions of autonomy and in the process let the city adjust to its actual carrying capacity.

In both instances, as ergos will need to be issued before actual generation, they will be issued periodically based on forecasts of energy supply. If there is a goal for autonomy then the capacity constraint will tend to shorten the validity period of actual ergos issued (Case 1). If there is a grid connection, and the target is an annual net zero carbon operation (as is the case of Masdar City) then the accounting period can extend to the entire year thus allowing the ergo issuance to account for seasonal and variations in renewable energy generation (Case 2).

The principle behind supply side allocation is simple: the number of new ergos created each period is equal to the desired energy consumption of that period. This amount may deviate from the forecasted generation of that period if there is any seasonal adjustment factor or the use of pre-allocated credits. Pre-allocation of credits is described later and the seasonal adjustment factor is discussed below. For the Masdar CEA, the energy supply that forms the basis of the ergo budget is equal to the electricity and heat output from the renewable energy power plants of Masdar City. In some cases, seasonal adjustments to the number of credits issued each period can be made if there is a strong seasonal divergence of supply and demand of electricity. In Masdar City, it is anticipated that there may be excess generation during the winter months when cooling loads are low and a possible deficit during the summer months.

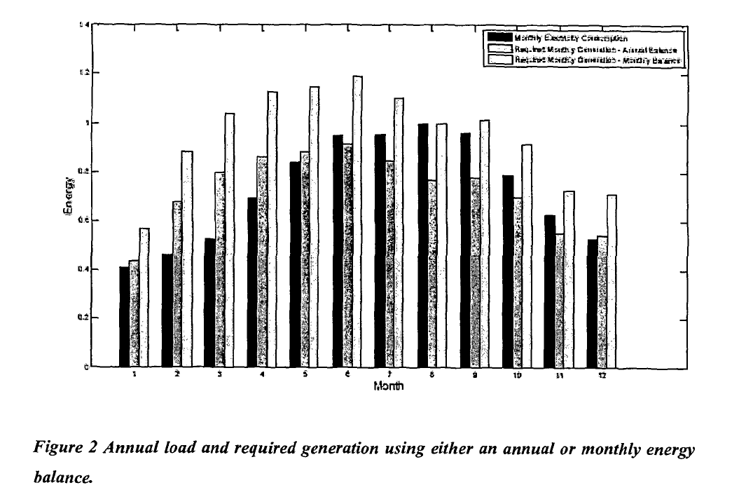

FIG. 2 shows normalized monthly electricity load data for Abu Dhabi and two options for the required monthly generation: (1) the generation and load must balance each month, or (2) they must balance over one year. The generation output is simply a scaled version of solar radiation data from Abu Dhabi to approximate solar power output. All values have been normalized to the annual peak of the monthly load. The plot shows that solar radiation peaks in June, whereas the electricity load peaks in August. In order to meet a monthly balance, sufficient capacity needs to be built to handle the August load, leading to excess generation in all remaining months and a net positive excess over the course of one year. For the annual balance, less capacity can be built and there is no excess generation after one year. In this scenario, it would be preferable to set the production requirements according to an annual balance, while issuing a monthly balance of credits. Credit allocation would incorporate this seasonality by setting the monthly allotment based on a desired demand profile (black bars) as opposed to the expected generation (gray bars).

An expression for the quantity of ergos issued for period n, Qₙ, is shown below,

Qₙ=∫₀^{T}E(t)dt+Qₙ₋₁−Cₙ₋₁Σⱼ₌ₙ₊₁^{M}PAE_{n,j}−Σ_{i=n-M}ⁿ⁻¹PAE_{i,n}+SAₙ. (3)

where E(t) is the energy supply forecast integrated over T, the duration of the issuance period, Cₙ₋₁ is the actual consumption of ergos over the period n−1, PAE_{i,j} represents the pre-allocated ergos issued in period i corresponding to generation in period j, M is the time horizon over which pre-allocation is permitted, and SAₙ is the seasonal adjustment (sum over 1 year equals zero). The energy supply forecast can be divided in to electrical energy output, E_{elec}(t) and thermal energy output, Eₜₕₑᵣₘₐₗ(t), where the latter is multiplied by an adjustment factor to convert thermal energy generation to electricity equivalent, p.

E(t)=E_{elec}(t)+Eₜₕₑᵣₘₐₗ(t)·p (4)

The adjustment factor, p, can be chosen to reflect the trade-off between producing thermal versus electrical energy. Since the generating capacity at any given time is fixed to produce one or the other, the trade-off can be represented in terms of the investment cost in new plant. The adjustment factor can then be set equal to the ratio between the levelized cost of energy (LCOE) for thermal and electrical energy.

$$p = \frac{{LCOE}_{th}}{{LCOE}_{el}} \qquad ( 5 )$$

The ergo budget for each period will be consumed by the different users and needs of the city including: a) residential users, b) commercial users, c) common city services (utilities), d) a visitor reserve, e) net electricity exports while the matured forward market obligations will also need to be accounted for. The total consumed credits in period n, is shown in Eq. 6. Consumed credits do not include credits sold on the spot market, e.g. Cᵣₑₛ does not include a residential user's sale of extra credits.

Cₙ=C_{res,n}+C_{comm,n}+C_{util,n}+C_{vis,n}+C_{exp,n}+C_{forw,n} (6)

Here, Cᵣₑₛ is the consumption of ergos by residential users, C_{comm} is the consumption of ergos by commercial users, Cᵤₜᵢₗ is for common utilities, Cᵥᵢₛ represents consumption of ergos by visitors, Cₑₓₚ is for retirement of ergos for exporting services, and C_{forw} is for retirement of ergos from matured forward markets.

The regular residential and commercial users could subscribe to different tiers according to the quantity of ergo provisions at a predetermined rate such that the cities energy targets are met. A simpler system, with the potential to be more equitable and more acceptable to users, is to allocate the ergos based on the surface area leased. The common city utilities providers will also be allocated ergos based on their expected resource use. Any ergos not allocated for demand by regular users, common utilities, and visitors represent additional power generation that can be exported to the external grid. If the CEA receives no surplus ergos then the local generation is only just sufficient to meet the city demand. If the CEA sets a high price to purchase ergos or increases the allocation for export, then reductions in demand are incentivized which allows for additional generation to be exported. It is also possible to merge the common utility budget to the regular user one and charge each regular user's account for an ergo amount that reflects common utility energy usage. This allocation system is shown in Eq. 7,

$${q}_{r , n} = \frac{{Q}_{n} - {EC}_{vts} - {EC}_{ex p} - {\sum }_{s} {ef}_{s , n}}{A} \cdot {A}_{r} + {ef}_{r , n} \qquad ( 7 )$$

where qᵣ are the new ergos delivered to subscriber r, EC is the expected consumption of visitors, export energy and forward market matured obligations, ef_{r,n} are the ergo futures held by subscriber r and maturing during period n, A is the total leased area, and Aᵣ is the leased area for subscriber r.

The subscription fee is paid at each issuance period by the credit holder to the CEA. The value of the fee depends on the objectives of the CEA. If the CEA intends to recover the full capital and operating cost of the renewable energy generating equipment, then the subscription fee can be set equal to the average levelized cost of energy for the full generation portfolio. In some cases, a portion of the cost may be recovered through other means, such as through government subsidy. In an extreme case, when the full cost is recovered through payments outside of the MEC system, the subscription fee would be set to zero. The value of the subscription fee does not affect the market mechanism operation, which can be calibrated to be revenue neutral. Instead, it is most important in terms of cost recovery for the CEA and matching long-term energy supply to demand. The spot price in the ergo market, which is important for incentivizing demand adjustments in the shorter-term, is described in the following section.

The functioning of the market mechanisms associated with the MEC system is the key design feature for ensuring successful operation and meeting the renewable energy balance goals. This section first discusses the ubiquitous daily spot market operations and secondly the forward market functions that facilitate investment in future energy installations.

The ergo spot market provides the real-time exchange rate of ergos and monetary currency. It was noted further above that CEA is the sole issuer and buyer of ergos in the spot market and thus sets the exchange rate in real time by adjusting to demand trends. The decision to use a monopsony for the ergo market to emulate an efficient competitive market was based on an effort to maintain the ease of use of the MEC system and economic efficiency while retaining the expiration feature of ergos which is critical in making energy more tangible than a fiat currency. The theoretical efficient market would comprise of a large number of sellers (issuers of ergos) and buyers of energy that faced zero transaction costs and are armed with complete information. These idealized conditions cannot be replicated for retail energy markets as all assumptions are violated (the number of sellers and buyers is severely limited, there are large transaction costs involved given the low-dispatchability of renewable energy supply and the absence of viable small-scale energy storage, and finally perfect information even if available would require significant time investment noncommensurate to the utility derived by casual energy users). As a result, the alternative solution for maintaining market efficiency is to create a market maker/monopsonistic entity (the CEA in our case) that uses transparent price-setting algorithms and targets revenue neutrality. Hence, the price setting objective for the CEA is to prevent energy consumption from exceeding energy supply at the lowest cost and with a net zero revenue from the market operation.

The exact pricing algorithm will depend on the specifics of the MEC system application, namely whether it is dominated by strong capacity or strong energy constraints and it will need to be calibrated to the specifics of the user profile but the fundamental market mechanism described here can be retained. The goal of the price setting algorithm is to find a price that encourages users in aggregate not to exceed the total supply of credits over a specified accounting period. The accounting period can be expressed as a multiple of issuance periods, n=[1, N]. The objective function of the spot market shown in Eq. 8 minimizes the deviation of credits consumed versus credits issued at the beginning of the period, where the total credits consumed is expressed as an integral of the instantaneous consumption, which is a function of the instantaneous price and utility shown in Eq. 9. The constraint in Eq. 10 represents the requirement that consumption of credits does not exceed the total budget over the accounting period. Eq. 11 illustrates a revenue neutrality constraint, whereby the total revenue received by the CEA from the aggregate spot market transactions is zero. Eq. 12 shows a cost recovery constraint with the total payment received by the CEA through subscription payments equaling the total levelized cost of the MEC system, including generation and all administrative costs.

min(∫₀^{T}Kₙ(p(t),U(t))dt−Qₙ) (8)

where,

Cₙ=∫₀^{T}Kₙ(p(t),U(t))dt (9)

s.t.

Σₙ₌₀^{N}(Cₙ−Qₙ)≦0 (10)

∫₀^{T}p(t)·{K_{bought}(t)−K_{sold}(t)+[1−Sₙ/p(t)]·K_{surrend}(t)}dt−∫₀^{T}pₑₓₚ(t)Kₑₓₚdt=0 (11)

Σₙ₌₀^{N}(Wₙ−Sₙ·Qₙ)=0 (12)

where p(t) is the ergo spot market price at time t, K(t) is the actual ergo consumption at time t as a function of ergo price and of the time dependent utility U(t) of meeting the service needs of the MEC system users, Sₙ, is the base ergo price as defined by the subscription fee in the beginning of the period n, N is the number of periods in the carbon accounting cycle, K_{bought} are the ergos bought by users additional to their allocation Qn, K_{sold} are ergos sold by users, K_{surrend} are ergos surrendered by users when p(t)<Sₙ, and Wₙ is the total MEC system levelized cost for period n including externality pricing (if carbon credits are needed to balance extra ergo issuance).

Two possible mechanisms for determining the exchange rate are shown in Eq. 13 and Eq. 14. In both cases, the price is a function of the difference between the cumulative consumption and the integral of a desired demand curve \hat{K}(t), as it unfolds during the day.

Two Tier Pricing:

$$p ( t ) = \{ \begin{matrix}{p}_{import} & {\int }_{0}^{t} {K}_{n} ( x ) d x \geq {\int }_{0}^{t} {\hat{K}}_{n} ( x ) d x \\ {p}_{export} & {\int }_{0}^{t} {K}_{n} ( x ) d x < {\int }_{0}^{t} {\hat{K}}_{n} ( x ) d x\end{matrix} \qquad ( 13 )$$

With two tier pricing, it is assumed that the fixed import price will be higher than the fixed export price. In the case of Masdar City, the import price will include a premium in order to cover the costs of offsetting the carbon emission associated with importing power from outside the city. The final import price would then be higher than both the export price as well as the per unit subscription fee. The export price could potentially be greater, equal, or less than the subscription fee. If greater than the subscription fee, a consumer would always have a financial incentive for reducing demand. For a system with strong capacity constraints, when user demand exceeds total available ergos, the load would have to be curtailed. In such cases, the price of electricity at this point can be set to the value of the lost load to the consumer.

### Linear Differential Pricing:

p(t)+Sₙ+λ∫₀^{t}(Kₙ(x)−\hat{K}ₙ(x)) dx (14)

With linear differential pricing, the price is set proportional to the difference between the cumulative energy demand and the cumulative load. If the constant k is set equal to the subscription fee, Sₙ, then there will be no financial incentive to switch whenever the cumulative consumption is less than or equal to the cumulative generation. The value of the constant multiplier, λ, can be set once more information on the consumers' price elasticity of demand is known. A combination of a linear pricing and a two tier pricing can provide a linear response with upper and lower limits for the price. Other curves can be used to make price transitions smoother.

This pricing concept differs from prior energy exchanges in that the price is driven by the difference between the actual demand and a desired demand, as opposed to supply, and in that cumulative rather than instantaneous values are used. The use of the cumulative values of demand for devising the price signal reflects a system with dominant energy, as opposed to capacity, constraints during period n (i.e. there is adequate storage capacity to shift energy output within the period). It allows for an evenly distributed price that does not face abrupt price spikes or persistent price patterns. The ability to adjust the price of ergos according to a cumulative deficit or excess in energy generation provides a powerful incentive for meeting this objective.

The desired demand curve can be shaped for each day using historical data, weather forecasts, accounting for special events but can also be based on the forecasted supply generation profile. Using this approach may be particularly useful for adjusting demand patterns to the volatile supply profile of renewable energy generation in case of strong capacity constraints. This is not a critical point for Masdar City due to its dedicated grid connection but can be a useful mechanism for autonomous micro-grids with limited storage capabilities.

While the standing balance of ergos in a user's account provides a benchmark with regard to his or her individual behavior relative to the sustainable allocated amount, the market pricing provides information on the users' aggregate behavior relative to the entire City's available energy supply. Knowing ergos exchange rate and having the ability to trade them provides frugal users with the reward of selling surplus ergos at an advantageous rate and spendthrift users with the incentive to further change their behavior but also a penalty for exceeding sustainable limits. In addition, the MEC system establishes an opportunity cost for energy consuming activities; whereby the user forgoes the sale of the equivalent number of ergos in the spot market. As a result, average users are incentivized to shift their consumption to periods when the price of ergos is lower.

As result, the spot market concept maintains that the price is lower than the benchmark price S when actual consumption is lower than expected and vice versa. Users face the following basic (collapsed) choices:
1. p(t)<S. Positive ergo balance. Consuming desired service if utility U(t)>p(t) and surrendering ergos. Users are reimbursed the monetary difference and their monetary account is credited with S−p(t).
2. p(t)<S. Zero ergo balance. Consume desired service if U(t)>p(t). Users monetary account is charged with p(t).
3. p(t)>S. Positive ergo balance. Postponing or cancelling the consumption of a desired service if U(t)<p(t). If selling the extra credits users are reimbursed the full price p(t). Banking ergos in this case carries an opportunity cost of p(t)−S but also has an option value of keeping the ergo to be used before expiry at a time when the price and the utility of use are higher.
4. p(t)>S. Zero ergo balance. Consume desired service if U(t)>p(t). Users monetary account is charged with p(t).

In the cases where peak shaving or peak shifting is desired the pricing mechanism can be adjusted by shortening the period n of the MEC system. Such a measure would make sense in energy systems with stronger capacity constraints. On the other hand, when individual systems require more energy to provide the same function (e.g. a congested transportation system) then the higher energy charge automatically provides a congestion charging scheme without the need for changes in the pricing mechanism. Overall, the incentive to defer consumption acts as a citywide congestion-charging scheme that suppresses additional demand that would tax the system beyond its nominal capacity.

An alternate approach to using cumulative curves for the ADP and DDP would be to use the instantaneous demand values. For a system with stronger capacity constraints, this could potentially provide a faster signal to immediately correct for demand imbalances. The main challenge with this approach arises from the fact the ergos can be sold back to the CEA even if the corresponding demand reduction occurs in a different period. For example, if the validity period is 24 hours and a user sees a very high ergo price in the middle of the day, she could choose to sell the ergos immediately but reduce consumption later at night. The user gains from this strategy as long as the daily energy consumption does not exceed the daily ergo allowance. This could potentially lead to a situation where ergos are sold when power is needed most, but the actual demand reductions are only made when power is no longer needed. Therefore, for stronger energy constraints, the MEC scheme will need to reduce the length of the validity period so that ergos cannot be stored for periods longer than the system's storage capacity. Other corrective mechanisms may be possible, but require further study. This artifact of long-validity period ergos will not present significant problems for Masdar City which is connected to the electricity grid but it may cause problems if load shifting is particularly desired. In any case, mitigating factors that would allow a system with longer validity periods of ergos to support some demand shifting do exist. They include: (i) personal uncertainty of future need of ergos, (ii) aggregated behavior of users, and (iii) moral decision-making of informed users (i.e. active citizens may decide to defer consumption when ergo prices are high understanding that the City needs to adjust accordingly. The actual behavior of the MEC system is an emergent attribute that cannot be predicted a priori in its entirety.

The pricing mechanism needs to be tested with different formulations through simulation and experimental study. A successful formula would effectively manage demand without being overly repressive and unfair and without creating reinforcing feedback that could lead to a volatile exchange rate. The parameters for the chosen formula can be adjusted as more information on real elasticities of demand and learning curves for the use of the system become apparent. As an example of such learning, users may sell too many ergos initially and then face an expensive end of the period. As a reaction, they may then hoard ergos until their expiration. Software automation and well-designed interface features can certainly accelerate the adoption transition.

The MEC spot market system is designed to provide total energy supply and demand matching, but as described so far, it can only be effective when sufficient generation capacity is available. A forward market for MECs can also be established that can potentially help to identify and even finance future capacity needs, and possibly offset current renewable energy deficits with a future renewable energy capacity. These aspects of the MEC energy system are addressed by the forward markets discussed in the following section.

There are two primary mechanisms included in the MEC System forward markets: (1) Pre-Allocated Ergos (PAE) that explicitly extend the seasonal balancing mechanism over multiple periods by pre-allocating energy production, and (2) Ergo Futures (EF) which are traded in a typical futures market for ergos.

Pre-Allocated Credits:

For renewable energy developments with strong energy constraints like Masdar City, the MEC system can account for future renewable energy supply by issuing a portion of the future supply of ergos earlier in time. These pre-allocated ergos act as regular ergos and can support energy balance accounting during their period of issue. For example, if construction of a large renewable power plant is under way and will be operational in 2 years with a given nameplate output, a portion of that output can be allocated and issued as ergos before the system commences production. This of course means that in order to meet the net zero carbon target, when the facility is operational and until the “energy debt” is cleared only the remaining portion of the energy output can be translated into ergos and the rest will need to be exported to the grid without being doubly counted. If for example a portion of the anticipated annual output of a 10 MW PV installation was used to issue 150,000 ergos the year before its operation, then the year that the plant does operate the actual number of ergos that can be issued will need to be reduced by this amount. The equivalent energy will be exported to the connecting grid but would not be counted towards paying back the embodied carbon debt either. This can be particularly useful for net zero carbon cities as the growth of their energy demand may not map one on one with their energy capacity expansion. By issuing pre-allocated ergos, the CEA can identify current renewable energy capacity shortfalls, can raise partial funding to invest in capacity expansion, commits to installing new capacity, and prevents the build-up of an ergo deficit. In addition, pre-allocated ergos allow a trade-off between temporal generation of energy and purchase of carbon credits (e.g. Certified Emissions Reductions credits) in order to maintain net zero carbon status within a given timeframe. In order to reduce the chance of building up an excessive energy debt, the timeframe for pre-allocation (cf. Eq. 3) could be limited to a fraction of the capacity expansion planning horizon (e.g., 2-3 years).

Ergo Futures:

In order to facilitate energy planning and fund future capacity investments the MEC system can offer an energy investment mechanism through the issuance of ergos with a given activation time. These Ergo Futures are issued against future energy generation. Ergo Futures are the only type of ergos that can be bankable until their activation, after which they will operate as ordinary ergos and expire. Ergo Futures offer a guarantee to buyers that energy will be available to them at the date of activation. By offering a contract of guaranteed energy supply at a known price, the demand for futures can be used as an indication of future energy needs. Ergo Futures also provide financing of planned renewable energy generation projects and they also reduce the energy price risk for institutional energy consumers. Ergo Futures are fully tradeable (i.e. they can be bought and resold without restrictions) until their activation at which time they transition to regular ergos with a standard validity period.

In conclusion, the primary differences of the MEC Spot Market System with other energy pricing schemes is that (i) it is retail based, (ii) users cannot speculatively trade ergos, (iii) users cannot accumulate ergos due to their expiration, and (iv) it covers the entire energy value chain of a city or region and thus provides a de facto parallel currency for completing any service or product transaction in the city. By comparing the cumulative actual and desired demand curves rather than total availability or instantaneous demand curves allows the system to avoid predictable shortages and hence exchange rate inflation at the end of the a period while also preventing energy price volatility from momentary demand fluctuations.

### REFERENCES

IEA (2006) “2006 Energy Balance for the World”, International Energy Agency, Retrieved online on 11 May 2009, http://www.iea.org/Textbase/stats.
Berry, D., 2002. The market for tradable renewable energy credits. Ecological Economics, 42(3), 369-379.
Chandley, J. D., 2001. A Standard Market Design for Regional Transmission Organizations. The Electricity Journal, 14(10), 27-53.
Cramton, P., 2003. Electricity Market Design: The Good, the Bad and the Ugly. In HCISS'03. Hawaii.
IEA, 2006. 2006 Energy Balance for World. International Energy Agency. Available at: http://iea.org/Textbase/stats/index.asp [Accessed May 14, 2009].
Lijesen, M. G., 2007. The real-time price elasticity of electricity. Energy Economics, 29(2), 249-258.
Patrick, R. H. & Wolak, F., 2001. Estimating the customer-level demand for electricity under real-time market prices. NBER working paper.
Roh, J. H., Shahidehpour, M. & Fu, Y., 2007. Market-Based Coordination of Transmission and Generation Capacity Planning. Power Systems, IEEE Transactions on, 22(4), 1406-1419.
Schweppe, F. C., 1988. Spot pricing of electricity, Kluwer Academic Publishers.
Shrestha, G. & Fonseka, P., 2004. Congestion-driven transmission expansion in competitive power markets. Power Systems, IEEE Transactions on, 19(3), 1658-1665.
Zarnikau, J., 2008. Demand Participation in Restructured Markets. In F. P. Sioshansi, ed. Competitive Electricity Markets: Design, Implementation, Performance. Oxford, UK: Elsevier.

What is claimed is:

1. A method of managing consumption of energy in an energy market comprising a community of users, the method comprising:
providing energy generation facilities;
providing a central energy authority which issues energy currency units to users and which sets an exchange rate between the energy currency units and a monetary currency unit, the exchange rate varying with time, thereby setting a variable price for energy;
permitting users to consume energy currency units through use of energy consumptive services within the energy market; and
permitting users to buy and sell energy currency units from and to the central energy authority at the then prevailing exchange rate.

2. The method of claim 1, wherein the price of energy is set having regard to the difference between energy consumption and energy demand.

3. The method of claim 1, wherein the price of energy is set having regard to the difference between cumulative energy consumption and cumulative energy demand over a defined time period.

4. The method of claim 3, wherein the time period is one of a day, a week, a month and a year.

5. The method of claim 1, wherein the price of energy is adjusted by an amount proportional to the difference between cumulative energy consumption and cumulative energy demand over a defined time period.

6. The method of claim 5, wherein the time period is one of: a day, a week, a month and a year.

7. The method of claim 1, wherein each energy currency unit has a defined validity period at the end of which the energy currency unit is automatically converted to monetary currency units by the central energy authority.

8. The method of claim 1, wherein the energy constraint is a physical constraint governed by the capacity of the energy generation facilities, or a portion of the energy generation facilities.

9. The method of claim 1, wherein the energy constraint is governed by a requirement that a defined fraction of the energy market's consumption of energy is generated by certain kinds of energy generation facility.

10. The method of claim 1, further providing a grid connection to remote energy generation facilities serving a remote energy market, thereby permitting export of energy to and import of energy from the remote energy market.

11. The method of claim 10, wherein the central energy authority sets further exchange rates to price energy currency units exported to and imported from the remote energy market, so that the energy market has an internal price, an import price and an export price for energy.

12. The method of claim 11, wherein the import price includes a premium to cover the cost of offsetting the carbon emission of the imported energy.

13. The method of claim 11, wherein the export price is greater than the internal price to provide a financial incentive for users to reduce energy consumption.

14. An energy market operating according to the method of claim 1.
